(19) United States
(12) Patent Application Publication
(10) Pub. No.: US 2003/0092569 A1
(43) Pub. Date: May 15, 2003

(54) Catalyst ceramic body and process for its production

(76) Inventors: Kazuhiko Koike, Okazaki-city (JP); Masakazu Tanaka, Okazaki-city (JP); Tomohiko Nakanishi, Nishio-shi (JP); Miho Ito, Hoi-gun (JP)

Correspondence Address: NIXON & VANDERHYE, PC, 1100 N GLEBE ROAD, 8TH FLOOR, ARLINGTON, VA, 22201-4714, US

(21) Appl. No.: 10/290,459

(22) Filed: Nov. 8, 2002

(30) Foreign Application Priority Data
Nov. 12, 2001 (JP) 2001-345793
Sep. 26, 2002 (JP) 2002-280870

(51) Int. Cl. B01J 23/38

(52) U.S. Cl. 502/325

(57) ABSTRACT

A catalyst ceramic body employing a directly supporting carrier, wherein particle growth due to aggregation of the catalyst particles during loading of the catalyst is suppressed to yield fine particles, thereby improving the purification performance. According to the invention, the base material is cordierite with a portion of its constituent elements substituted, and when a catalyst component such as Pt is to be supported on a ceramic carrier capable of directly supporting a catalyst component on the introduced substituting elements, a precursor for the Pt is loaded and then sintered in a reducing atmosphere. Using a reducing atmosphere allows the metallization temperature to be as low as about 400° C., thereby reducing thermal vibration and suppressing aggregation in order to achieve an effect of reducing the mean particle size of the catalyst to about 100 nm or smaller.

### BACKGROUND OF THE INVENTION

1. Field of the Invention

The present invention relates to a catalyst ceramic body to be applied for automobile engine exhaust gas purifying catalysts and the like, and to a process for its production.

2. Description of the Related Art

A variety of catalysts have been proposed in the prior art for purification of noxious substances emitted from automobile engines. Exhaust gas purification catalysts generally employ high thermal shock-resistant cordierite honeycomb structures as carriers, the surfaces having coating layers composed of high specific surface area materials such as γ-alumina, supporting precious metal catalysts such as Pt. The coating layer is formed because of the relatively small specific surface area of the cordierite, the γ-alumina being used to increase the surface area of the carrier in order to support the necessary amount of catalyst component.

However, formation of the coating layer increases the thermal capacity of the carrier and thus delays quick activation, resulting in a smaller pore area and thereby increasing pressure loss. Furthermore, because of the low heat resistance of γ-alumina itself, aggregation of the catalyst component and significant reduction of purification performance are problems. In recent years, therefore, methods of improving the specific surface area of cordierite itself have been explored. For example, Japanese Examined Patent Publication HEI No. 5-50338 describes acid treatment followed by heat treatment to elute out a portion of the cordierite constituents, and supporting the catalyst component in the formed voids. This method, however, has not been practical because the acid treatment and heat treatment cause destruction of the cordierite crystal lattice and thus reduce the strength.

The present inventors had previously proposed a ceramic carrier capable of directly supporting the necessary amount of catalyst component without formation of a coating layer for improved specific surface area while maintaining strength (Japanese Patent Application No. 2000-104994). This directly supporting ceramic carrier has a plurality of pores formed by lattice defects in the crystal lattice of the base ceramic surface, by replacing at least one of the constituent elements of the base ceramic with an element having a is different valency. Because the pores are extremely fine they produce virtually no change in the specific surface area, and it is therefore possible to directly support the necessary amount of catalyst component without causing the conventional problem of reduced strength.

Because such ceramic carriers capable of directly supporting catalyst components have fine pores, the catalyst particles are preferably small for reliable support of the catalyst particles in the pores, in order to prevent deterioration by migration and aggregation of the catalyst particles. Moreover, since a fine catalyst particle size results in greater diffusion of the catalyst component on the carrier surface, high catalyst performance can be achieved with a small amount of supported catalyst. However, it has become clear that when catalyst components are supported on such directly supporting ceramic carriers by ordinary methods, exposure to high temperature during the course of loading the catalyst components and sintering results in migration and aggregation of the catalyst particles to form larger sized particles. The sintering temperature may be lowered in order to inhibit thermal oscillation of the catalyst particles, but a temperature of at least 600° C. is usually necessary for metallization of the precious metal catalyst such as Pt, and this has imposed a limit on the degree of fineness of the catalyst particles.

### SUMMARY OF THE INVENTION

It is an object of the present invention to obtain a catalyst ceramic body employing a directly supporting ceramic carrier, wherein the catalyst ceramic body is resistant to thermal degradation and exhibits high catalyst performance by the presence of fine catalyst particles.

According to a first aspect of the invention, there is provided a catalyst ceramic body comprising a catalyst component supported on a ceramic carrier, wherein the ceramic carrier is capable of directly supporting a catalyst component on the base ceramic surface, and the catalyst component is catalytically activated by sintering a precursor of the catalyst component in a reducing atmosphere.

Catalyst component precursors, such as hexachloroplatinic acid, for example, have high metallization temperatures which have conventionally required temperatures of 600° C. or above for sintering, and it has therefore not been possible to sufficiently reduce the particle sizes due to aggregation of the catalyst particles at high temperature. According to the present invention, the catalyst component is sintered in a reducing atmosphere to allow a lower metallization temperature, thereby inhibiting aggregation of the catalyst particles and achieving a fine mean particle size of below 100 nm, for example. It is thus possible to obtain a catalyst ceramic body with a fine catalyst particle size rendering it resistant to thermal degradation and giving high catalyst performance

According to a second aspect of the invention, there is provided a process for production of a catalyst ceramic body comprising a catalyst component supported on a ceramic carrier capable of directly supporting a catalyst component on the base ceramic surface, wherein the precursor of the catalyst component is loaded in the ceramic carrier and sintered in a reducing atmosphere. According to this process, as mentioned above, the metallization temperature may be reduced and aggregation of the catalyst particles during sintering can be inhibited, to produce a catalyst ceramic body with a mean particle size of 100 nm or smaller.

The mean particle size of the supported catalyst particles is preferably no greater than 100 nm. As mentioned above, catalyst particles sintered in a reducing atmosphere are rendered as fine particles with a mean particle size of 100 nm or smaller, thereby allowing high diffusion on the carrier surface and exhibiting high purification performance.

A method of supplying a reducing gas into the sintering furnace may be employed to create the reducing atmosphere. Here, the reducing gas used may be one containing H₂ gas, CO gas or a flammable gas.

Alternatively, a similar effect may be achieved by loading the precursor of the catalyst component and then coating a reducing agent onto the precursor of the catalyst component before sintering, so that a reducing atmosphere forms at least near the precursor of the catalyst component.

By lowering the sintering temperature to below 600° C., it is possible to inhibit aggregation of the catalyst particles due to high temperature and thereby reduce the catalyst particle size.

The precursor of the catalyst component may also be a salt containing the catalyst component.

According to these aspects of the invention, a precious metal may be suitably used as the catalyst component, and in the form of fine particles it will exhibit high purification performance.

The precursor of the catalyst component may be, specifically, any one selected from the group consisting of hexachloroplatinic acid, platinum nitrate, dinitrodiammine platinum, tetraammine platinum nitrate, tetraammine platinum chloride, platinum acetylacetonate, rhodium chloride, rhodium nitrate, rhodium acetate, rhodium acetylacetonate, palladium chloride, palladium nitrate, palladium acetate, palladium acetylacetonate, tetraammine palladium nitrate and tetraammine palladium chloride.

According to a third aspect of the invention, the ceramic carrier of the catalyst ceramic body comprising a catalyst component on a ceramic carrier is a ceramic carrier capable of directly supporting the catalyst component on the base ceramic surface. The catalyst component is characterized by being catalytically is activated by sintering of a starting material other than a strong acid or strong base as the precursor of the catalyst component.

According to the invention, a starting material other than a strong acid or strong base is used as the precursor of the catalyst component, instead of altering the sintering atmosphere. By using such as a starting material, the metallization temperature can be lowered and aggregation of catalyst particles inhibited to achieve a fine particle size of below 100 nm, for example. It is thus possible to obtain a catalyst ceramic body with a fine catalyst particle size rendering it resistant to thermal degradation and giving high catalyst performance.

According to a fourth aspect of the invention, there is provided a process for production of a catalyst ceramic body comprising a catalyst component supported on a ceramic carrier capable of directly supporting a catalyst component on the base ceramic surface, wherein a starting material other than a strong acid or strong base is loaded in the ceramic carrier and sintered in air as the precursor of the catalyst component. According to this process, as mentioned above, the metallization temperature may be reduced and aggregation of the catalyst particles during sintering can be inhibited, to produce a catalyst ceramic body with a mean particle size of 100 nm or smaller.

The mean particle size of the supported catalyst particles is preferably no greater than 100 nm. As mentioned above, catalyst particles sintered in a reducing atmosphere are rendered as fine particles with a mean particle size of 100 nm or smaller, thereby allowing high diffusion on the carrier surface and exhibiting high purification performance. According to this process, the sintering temperature is lowered to below 600° C., to obtain the same effect of inhibiting aggregation of the catalyst particles due to high temperature and thereby reduce the catalyst particle size. Also, using a weakly acidic, neutral or weakly basic starting material as the precursor of the catalyst component is preferred for a greater effect. Specifically, the aforementioned effect may be easily obtained if the precursor of the catalyst component is a starting material with a solution pH of 4-10 when the catalyst metal concentration is 0.01 mol/L.

A catalytic precious metal is preferably used as the catalyst component, to exhibit high purification performance as fine particles. Specifically, the precursor of the catalyst component may be any one selected from the group consisting of tetraammine platinum nitrate, tetraammine platinum chloride, platinum acetylacetonate, rhodium acetate, rhodium acetylacetonate, palladium acetate, palladium acetylacetonate, tetraammine palladium nitrate and tetraammine palladium chloride.

The mean particle size of the catalyst particles is more preferably no greater than 50 nm, as higher catalytic performance can be achieved with a smaller amount of catalyst carrier.

The ceramic carrier may be one which has a plurality of pores capable of directly supporting a catalyst on the base ceramic surface, and which is capable of directly supporting the catalyst component in those pores. This will give a catalyst body having the catalyst component directly supported on the ceramic carrier without using a coating layer.

The pores, specifically, may be defects in the ceramic crystal lattice, fine cracks in the ceramic surface and/or loss of elements constituting the ceramic.

The widths of the fine cracks are preferably no greater than 100 nm in order to ensure strength of the carrier.

In order to permit support of the catalyst component, the pores may have a diameter or width of up to 1000 times the diameter of the catalyst ion to be supported, in which case a number of pores of 1×10¹¹/L or greater will allow support of an equivalent amount of catalyst component as according to the prior art.

According to the invention, the ceramic carrier used may have one or more elements of the base ceramic substituted by an element other than a constituent element, so that the catalyst component can be directly supported on the substituting element.

In this case, the catalyst component is preferably supported by being chemically bonded to the substituting element. Chemical bonding of the catalyst component will improve the retention and evenly disperse the catalyst component in the carrier to inhibit aggregation, thereby further preventing degradation with prolonged use.

The substituting element used may be one or more elements having a d or f orbital among the electron orbitals. An element with a d or f orbital among the electron orbitals is preferred for easier bonding with the catalyst component.

The ceramic carrier is preferably one containing cordierite as a component. Using cordierite will improve the thermal shock resistance.

### BRIEF DESCRIPTION OF THE DRAWINGS

FIGS. 1(a) and 1(b) are schematic views illustrating the process for production of a catalyst ceramic body according to the first aspect of the invention, and its effect.

FIGS. 2(a) and 2(b) are schematic views illustrating a process for production of a catalyst ceramic body according to the prior art, and its associated problems. FIGS. 3(a) and 3(b) are schematic views illustrating the process for production of a catalyst ceramic body according to the third aspect of the invention, and its effect.

FIGS. 4(a) and 4(b) are schematic views illustrating a process for production of a catalyst ceramic body according to the prior art, and its associated problems.

FIGS. 5(a) and 5(b) are bar graphs showing the metallization temperatures for Pt-based and Rh-based precursors.

### DESCRIPTION OF THE PREFERRED EMBODIMENTS

The present invention will now be explained in greater detail with reference to the attached drawings. The catalyst ceramic body of the invention employs a ceramic carrier capable of directly supporting a catalyst component on the base ceramic surface, wherein a precious metal catalyst such as Pt, Rh, Pd or the like is directly supported as the catalyst component on the ceramic carrier. The precious metal catalyst particles are directly supported on the ceramic carrier without a coating layer. The catalyst ceramic body of the invention is preferably used, for example, as an automobile exhaust gas purification catalyst, and since no coating layer is necessary, the thermal capacity and pressure loss are reduced, while there is no impairment of the catalyst performance due to degradation of the coating layer.

The base ceramic used for the ceramic carrier is preferably one composed mainly of cordierite, represented by the theoretical composition 2MgO.2Al₂O₃.5SiO₂, for example. For use as an automobile catalyst, the base ceramic will usually be formed into a honeycomb structure having a plurality of channels in the direction of gas flow, and fired to produce a ceramic carrier. Because of the excellent heat resistance of cordierite it is preferred as an automobile catalyst for use under high-temperature conditions, but instead of cordierite as the base ceramic there may be used, for example, alumina, spinel, aluminum titanate, silicon carbide, mullite, silica-alumina, zeolite, zirconia, silicon nitride, zirconium phosphate and the like. The carrier form is not limited to a honeycomb, and may be another form such as pellets, powder, foam, hollow fibers, fibers, or the like.

In order to allow direct supporting of the catalyst component, the ceramic carrier of the invention either has a plurality of pores capable of directly supporting the catalyst component, or has a plurality of substituting elements capable of directly supporting the catalyst component. Pores capable of directly supporting the catalyst component may be, specifically, defects in the ceramic crystal lattice (oxygen defects or lattice defects), fine cracks in the ceramic surface and/or loss of elements constituting the ceramic, and they may also be formed by a combination of these. Elements capable of directly supporting the catalyst component are elements introduced by replacing one or more elements among those constituting the base ceramic with elements other than the constituent elements. The ceramic carrier may directly support the catalyst component by these pores or substituting elements in order to allow support of the catalyst component while maintaining high strength and without formation of a high specific surface area coating layer of γ-alumina or the like.

A ceramic carrier with a plurality of pores capable of directly supporting the catalyst component on the base ceramic surface will be explained first. The diameter of the supported catalyst component ions will usually be about 0.1 nm, and therefore the pores formed on the cordierite surface will be capable of supporting the catalyst component ions if they have a diameter or width of at least 0.1 nm. In order to guarantee the ceramic strength, the pore diameter or width is preferably as small as possible at no greater than 1000 times the size of the catalyst component ions (100 nm). It is more preferably from 1-1000 times (0.1-100 nm). The depths of the pores are preferably at least ½ the diameter of the catalyst component ions (0.05 nm) in order to hold them. At this size, the number of pores is at least 1×10¹¹ pores/L, preferably at least 1×10¹⁶ pores/L and more preferably at least 1×10¹⁷ pores/L in order to allow support of the same amount of catalyst component (1.5 g/L) as by the prior art.

Oxygen defects and lattice defects (metal vacancies and lattice distortions) are present in the crystal lattice defects among the pores formed in the ceramic surface. The oxygen defects are produced by a lack of oxygen in the ceramic crystal lattice, whereby the catalyst component can be supported in the pores formed by the missing oxygen. Lattice defects are produced by incorporating oxygen in excess of the amount necessary to form the ceramic crystal lattice, whereby the catalyst component can be supported in the pores formed by lattice distortions and metal vacancies.

Specifically, the number of pores in the ceramic carrier will at least satisfy the numbers prescribed above if the cordierite honeycomb structure contains at least 4×10⁻⁶% and preferably at least 4×10⁻⁵% of cordierite crystals having one or more oxygen defects or lattice defects in the unit crystal lattice, or if it contains at least 4×10⁻⁸ and preferably at least 4×10⁻⁷ of one type of oxygen defect or lattice defect per cordierite unit crystal lattice. The details regarding the pores and their method of formation will now be explained.

In order to form oxygen defects in the crystal lattice, a cordierite-forming starting material including an Si source, Al source and Mg source is shaped, degreased and then fired, and as described in Japanese Patent Application No. 2000-104994, the method employed may be [1] conducting the firing with reduced pressure or a reducing atmosphere as the firing atmosphere and [2] conducting the firing in a low oxygen concentration atmosphere using a compound containing no oxygen for at least a portion of the starting material, in order to create a lack of oxygen in the firing atmosphere or in the starting material, or [3] replacing a portion of at least one of the constituent elements of the ceramic other than oxygen with an element having a lower valency than that element. In the case of cordierite, the structural elements are Si(4+), Al(3+) and mg(2+) which all have positive charges, and therefore substitution of these with an element having a lower valency will create a positive charge vacuum corresponding to the valency difference with the substituting element and the amount of substitution, such that O(2−) having a negative charge is released to maintain electrical neutrality for the crystal lattice, thereby forming oxygen defects.

Lattice defects may be formed by [4] replacing a portion of a ceramic constituent element other than oxygen with an element having a greater valency than that element. If at least a portion of the cordierite constituent elements Si, Al and Mg are substituted by an element having a greater valency, they will create a positive charge excess corresponding to the valency difference with the substituting element and the amount of substitution, such that O(2−) having a negative charge is incorporated in the amount necessary to maintain electrical neutrality for the crystal lattice. The incorporated oxygen becomes a hindrance preventing orderly arrangement of the cordierite crystal lattice, and forming crystal distortions. The firing atmosphere in this case is air in order to supply sufficient oxygen. Also, a portion of the Si, Al and Mg are released to maintain electrical neutrality, forming voids. The sizes of the defects are believed to be on the order of no more than a few Angstroms, and therefore the specific surface area cannot be measured by ordinary specific surface area measurement methods such as the BET method using nitrogen atoms.

There is a correlation between the number of oxygen defects and lattice defects and the amount of oxygen in the cordierite, where support of the necessary amount of catalyst component requires an oxygen amount of less than 47 wt % (oxygen defects) or greater than 48 wt % (lattice defects). If by formation of oxygen defects the oxygen amount decreases below 47 wt %, the number of oxygen atoms in the cordierite unit crystal lattice will be less than 17-2, and the lattice constant of the b₀ axis of the cordierite crystal will be less than 16.99. If by formation of lattice defects the oxygen amount increases above 48 wt %, the number of oxygen atoms in the cordierite unit crystal lattice will be greater than 17.6, and the lattice constant of the b₀ axis of the cordierite crystal will be either greater than or less than 16.99.

A ceramic carrier having an arrangement with a plurality of elements capable of catalyst support on the base ceramic surface by element substitution will now be explained. Here, the elements replacing the constituent elements of the ceramic, for example in the case of cordierite, the elements substituting for the constituent elements other than oxygen, such as Si, Al or Mg, may be ones having higher binding force with the catalyst component to be supported than do those constituent elements, and which are capable of supporting the catalyst component by chemical bonding. Specifically there may be mentioned elements different from the constituent elements which also have a d or f orbital among their electron orbitals, and preferably elements either having an empty d or f orbital or having two or more oxidation states are used. An element having an empty d or f orbital bonds readily to the catalyst component because its energy potential is close to that of the supported catalyst component and readily donates electrons. Elements having two or more oxidation states are also expected to have a similar effect as they can readily donate electrons.

Specific examples of elements having empty d or f orbitals include W, Ti, V, Cr, Mn, Fe, Co, Ni, Zr, Mo, Ru, Rh, Ce, Ir and Pt, and any one or more of these elements may be used. Among these elements, W, Ti, V, Cr, Mn, Fe, Co, Mo, Ru, Rh, Ce, Ir and Pt are elements with two or more oxidation states. Other specific examples of elements with two or more oxidation states include Cu, Ga, Ge, Se, Pd, Ag and Au.

When a constituent element of a ceramic is to be replaced by one of such substituting elements, a method may be employed wherein the starting material for the substituting element is added to and kneaded with a ceramic starting material in which a portion of the starting material for the constituent element to be replaced has already been reduced to a degree corresponding to the amount of substitution. This is then shaped into a honeycomb form, for example, dried and then degreased and fired in air, according to ordinary methods. The thickness of the cell walls of the ceramic carrier is usually preferred to be less than 150 μm because a smaller wall thickness produces lower thermal capacity. According to an alternative method, a portion of the starting material for the constituent element to be replaced is first reduced to a degree corresponding to the amount of substitution and then kneaded, shaped and dried by ordinary methods, and finally impregnated with a solution containing the substituting element. After removal from the solution, it is then similarly dried and degreased and fired in air. This type of method in which the molded article is impregnated with a solution is preferred since it allows more substituting element to be included in the molded article surface, such that element substitution occurs more readily on the surface during firing to produce a solid solution.

The amount of the substituting elements may be a total in a range from 0.01% to 50% and preferably 5-20% with respect to the number of atoms of the replaced constituent elements. When the substituting elements are elements of different valency from that of the constituent elements of the ceramic, lattice defects or oxygen defects will be simultaneously produced corresponding to the difference in valency, but defects will not be produced if a plurality of substituting elements are used in such a manner that the sum of the oxidation numbers of the substituting elements and the sum of the oxidation numbers of the replaced constituent elements are equal. If adjustment is thus made to avoid an overall change in the valency, then it can be ensured that the catalyst component will be supported only by bonding with the substituting element.

Thus, using a ceramic carrier in which a portion of the constituent elements of the base ceramic is replaced by elements having greater bonding strength with the catalyst component is advantageous since direct support of the catalyst component is possible without a coating layer, and firmer bonding with the base ceramic can be achieved.

The catalyst ceramic body of the invention is obtained by directly loading a catalyst component such as Pt on the aforementioned ceramic carrier. The catalyst component may be loaded by a method in which a precursor of each catalyst component is loaded into the ceramic carrier, and then sintering is performed. It is a feature of the invention that when a catalyst component such as Pt is directly supported on the ceramic carrier, the particle growth of the catalyst is suppressed during catalytic activation by (1) sintering in a reducing atmosphere or (2) selecting a suitable catalyst component precursor. The supported catalyst metal particles may thereby be rendered fine to a mean particle size of 100 nm or smaller. The details regarding these loading methods by (1) and (2) are explained below.

For the loading method by (1), in most cases a salt containing the catalytic component may be used as the catalyst component precursor to be supported. Specifically, a chloride, sulfate, nitrate, etc. of Pt, Rh, Pd or the like, for example, hexachloroplatinic acid, platinum nitrate or platinum dinitrodiammine as a precursor of Pt, rhodium chloride, rhodium nitrate or the like as a precursor of Rh, or palladium chloride or palladium nitrate as a precursor of Pd. As alternatives to these strongly acidic or strongly basic starting materials there may be mentioned weakly acidic, neutral or weakly basic starting materials such as, for example, tetraammine platinum nitrate, tetraammine platinum chloride or platinum acetylacetonate as a precursor of Pt, rhodium acetate or rhodium acetylacetonate as a precursor of Rh, or palladium acetate, palladium acetylacetonate, tetraammine palladium nitrate or tetraammine palladium chloride as a precursor of Pd, and it is sufficient to select any one of these starting materials for use.

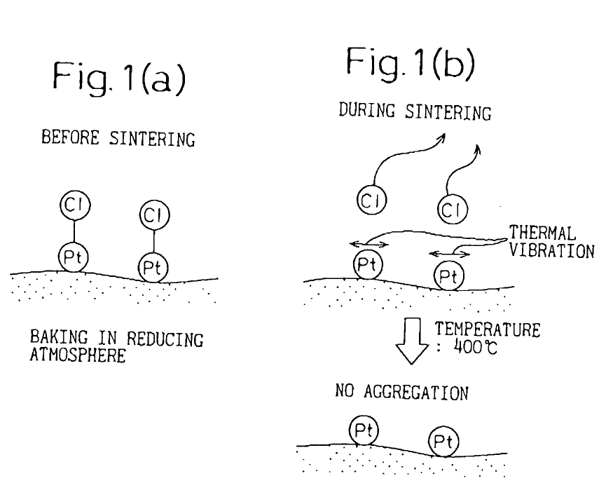

FIGS. 1(a) and 1(b) are illustrations of using Pt as the catalyst component, where the ceramic carrier is immersed in a solution containing a salt of Pt, such as an aqueous solution of hexachloroplatinic acid, the excess solution is removed by air blowing or the like, and then drying is performed with a drier. In this state, as shown in FIG. 1(a), the Pt is supported on the carrier surface while bonded to Cl, and then the Pt is metallized by sintering in a reducing atmosphere.

A method of supplying a reducing gas during the sintering may be employed to create the reducing atmosphere. The reducing gas used may be one containing H₂ gas, CO gas or a flammable gas at a concentration of 0.1% or greater, with other inert gas components such as N₂. The sintering temperature will usually be lower than 600° C., preferably 500° C. or below and more preferably 400° C. or below, with a lower temperature providing a higher effect of inhibiting aggregation and reducing the catalyst particle size.

In the method described above, the entire inside of the furnace is a reducing atmosphere, but alternatively, a reducing atmosphere may be created only around the catalyst by coating a reducing agent after supporting the catalyst component. The reducing agent may be an organic binder or lubricant used for molding of honeycomb structures, and specifically there may be used methyl cellulose, polyvinyl alcohol, glycerin or the like. As an example, the ceramic carrier is immersed for a very short time in a solution of glycerin and water in a volume ratio of 10:1, and after being taken out, the excess solution is removed to form a coating containing the reducing agent on the surface of the catalyst component. This may then be dried and sintered in air to produce a reducing atmosphere only around the catalyst. The sintering temperature will usually be a temperature lower than 600° C., preferably 500° C. or below and more preferably 400° C. or below.

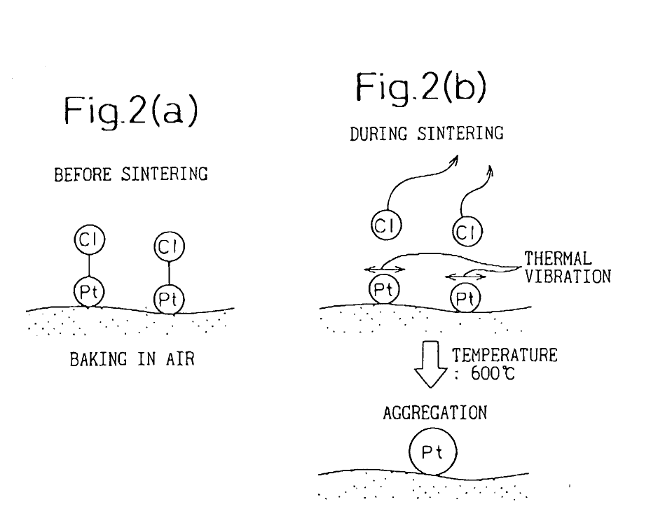

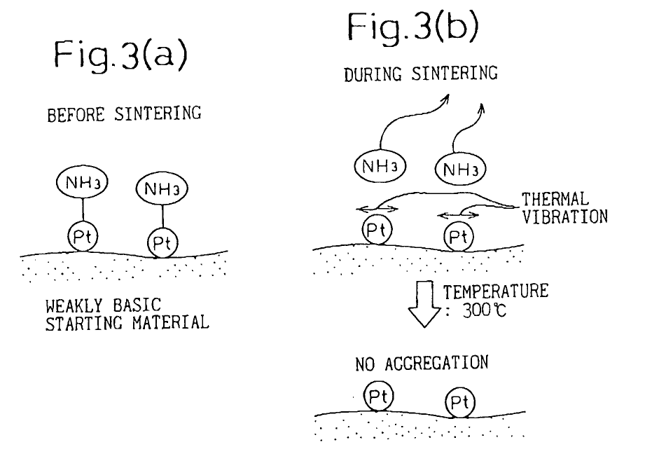

Catalyst components have conventionally been sintered in air, as shown in FIGS. 2(a) and (b), but catalysts have a high metallization temperature in air, requiring a temperature of about 600° C. in the case of hexachloroplatinic acid, for example. This is because of the strong bond between Pt and Cl which requires high thermal energy for dissociation; however, the high temperature of about 600° C. in air for metallization of Pt results in high thermal vibration of the Pt particles. It has therefore been difficult to achieve fine particles due to particle growth as the catalyst aggregates during metallization. On the other hand, according to the present invention as shown in FIGS. 1(a) and (b), the sintering atmosphere used is a reducing atmosphere of H₂ or the like, which promotes dissociation between Pt and Cl bonded thereto and allows metallization to be accomplished at a low temperature of about 400° C. In other words, because of the low atmosphere temperature of about 400° C. for metallization of the Pt, thermal vibration of the Pt particles is reduced and aggregation is inhibited, such that the catalyst particles can exist in a finer state.

When a reducing agent is coated, the reducing agent is gasified by heating and migrates to an area near the catalyst precursor. Therefore, by creating a reducing atmosphere only near the catalyst component during sintering it is possible to promote metallization of the catalyst component to obtain a similar effect.

For the loading method by (2), a starting material other than a strong acid or strong base is used as the precursor for the catalyst component to be supported. Specifically, a weakly acidic, neutral or weakly basic starting material containing a precious metal such as Pt, Rh or Pd as the catalyst component, for example, tetraammine platinum nitrate, tetraammine platinum chloride or platinum acetylacetonate as a precursor of Pt, rhodium acetate or rhodium acetylacetonate as a precursor of Rh, or palladium acetate, palladium acetylacetonate, tetraammine palladium nitrate or tetraammine palladium chloride as a precursor of Pd, and it is sufficient to select any one of these starting materials for use. Among these, rhodium acetate and palladium acetate are weakly acidic, platinum acetylacetonate, rhodium acetylacetonate and palladium acetylacetonate are neutral, and tetraammine platinum nitrate, tetraammine platinum chloride, tetraammine palladium nitrate, tetraammine palladium chloride are weakly basic.

Naturally, other weakly acidic, neutral or weakly basic starting materials may also be used. A weakly acidic, neutral or weakly basic starting material as a catalyst component precursor is generally a starting material which gives a solution of pH 4-10 when the catalytic precious metal concentration is 0.01 mol/L. The pH values for weakly acidic, neutral and weakly basic starting materials and for strongly acidic and strongly basic starting materials are listed below.

Pt-based tetraammine platinum nitrate: pH=7.59

(Dinitrodiammine platinum nitrate: pH=1.36)

Rh-based Rhodium acetate: pH=4.00

(Rhodium nitrate: pH=2.00)

Pd-based tetraammine palladium: pH=7.09

In FIGS. 3(a) and 3(b), an aqueous solution of, for example, tetraammine platinum nitrate as the Pt precursor is used, and the ceramic carrier is immersed therein, the excess solution is removed by air blowing or the like, and then drying is performed with a drier. In this state, as shown in FIG. 3(a), the Pt is supported on the carrier surface while bonded to NH₃, and then the Pt is metallized by sintering. The sintering atmosphere is air in this case, while the sintering temperature is usually lower than 600° C., preferably 500° C. or below and more preferably 400° C. or below, with a lower temperature providing a higher effect of inhibiting aggregation and reducing the catalyst particle size.

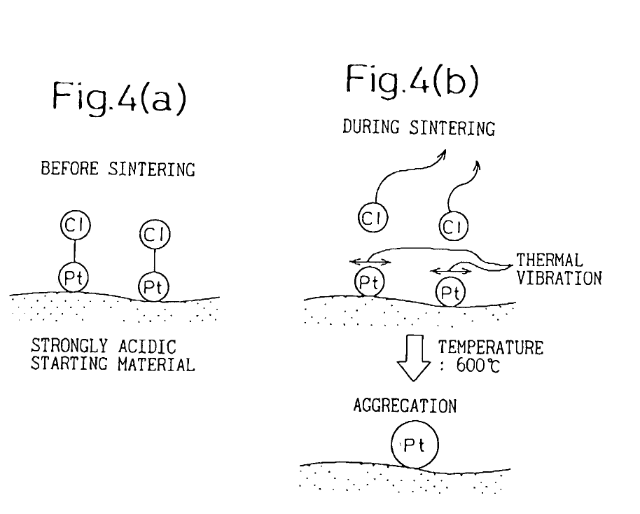

As shown in FIGS. 4(a) and 4(b), when strongly acidic hexachloroplatinic acid is used as the Pt precursor with sintering in air, the metallization temperature of the catalyst is high (for example, 600° C.), thereby increasing the thermal vibration of the Pt. The catalyst therefore undergoes particle growth along with metallization, making it difficult to achieve fine particles. According to the present invention, however, a weakly basic starting material such as in FIGS. 3(a) and 3(b), or a weakly acidic or neutral starting material, is used, resulting in weaker bonding strength between the catalyst metal component and the other sections than when a strong acid or strong base is used. Consequently, the thermal energy considered necessary for dissociation is reduced, thereby allowing metallization to be accomplished by sintering at low temperature (for example, 300° C.). This can inhibit aggregation by thermal vibration of Pt, and thus provide fine catalyst particles.

By applying the loading methods (1) and (2) above it is possible to suppress the catalyst metal particle growth. The mean size of the catalyst particles is metallized in this manner will vary depending on the sintering temperature, etc., but will usually be no greater than 100 nm, preferably no greater than 50 nm and even more preferably no greater than 25 nm. The purification performance is therefore improved by increase of the overall surface area using the same amount of supported catalyst.

The embodiment described above was explained for using a catalytic precious metal such as Pt, Rh, Pd or the like as the catalyst component, but metals other than precious metals may be used instead to achieve the same effect of inhibiting aggregation during metallization by sintering. When a plurality of catalyst components are used, the loading and sintering may be accomplished repeatedly at different times for each catalyst component, or the loading and sintering may be carried out simultaneously for all. Cocatalyst components such as CeO₂ may of course be added to the catalyst ceramic body of the invention depending on the purpose of use.

### EXAMPLE 1

### Comparative Example 1

Catalyst ceramic bodies were manufactured by a sintering method in a reducing atmosphere, and the effects were evaluated. The cordierite starting materials talc, kaolin, alumina and aluminum hydroxide were used and formulated into a near theoretical cordierite composition, together with WO₃ corresponding to 5% of the cordierite constituent Si and CoO also corresponding to 5% Si. Appropriate amounts of a binder, lubricant, humectant and moisture were added to the starting material, and kneaded into a clay-like material which was then formed into a honeycomb shape having a cell wall thickness of 100 μm, a cell density of 400 cpsi and a diameter of 50 mm. After drying the honeycomb structure, it was fired in air at 1390° C. to obtain a ceramic carrier capable of directly supporting a catalyst component at the substituting elements (W, Co).

In order to load Pt and Rh as catalyst components into the obtained ceramic carrier, an ethanol solution was prepared containing 0.035 mol/L hexachloroplatinic acid and 0.025 mol/L rhodium chloride. The ceramic carrier was immersed in the solution for 5 minutes, the excess solution was removed by air blowing, and then drying was performed for 1 hour with a drier at 110° C. This was then sintered at 400° C. in a reducing atmosphere using H₂ gas as the reducing gas, for metallization of the Pt and Rh to obtain a catalyst ceramic body according to the invention (Example 1). For comparison, a cordierite ceramic carrier manufactured by the same method was used for immersion in an ethanol solution having the same concentrations of hexachloroplatinic acid and rhodium chloride, drying, and then sintering in air at 600° C. to obtain a catalyst ceramic body (Comparative Example 1).

For evaluation of the purification performance of the catalyst ceramic bodies of Example 1 and Comparative Example 1, a model gas containing C₃H₆ was introduced, and the 50% purification temperature for C₃H₆ was measured. The evaluation conditions were as shown below, and the 50% purification temperature was examined initially and after thermal endurance (air, 1000° C., 24 hours).

Model gas

C₃H₆: 500 ppm

O₂: 2.5%

N₂: balance

SV=10,000

As a result, the 50% purification temperature for Example 1 was 157° C. When the catalyst particle size was measured by the CO adsorption method, the average was found to be 10 nm. The 50% purification temperature for Comparative Example 1 as 210° C., and the catalyst mean particle size was 55 nm. It was thus confirmed that sintering in a reducing atmosphere can lower the metallization temperature, reduce the catalyst mean particle size and thereby lower the 50% purification temperature to achieve markedly improved purification performance.

### Example 2

A catalyst ceramic body was manufactured by a sintering method with coating of a reducing agent, and the effect was evaluated. The cordierite starting materials talc, kaolin, alumina and aluminum hydroxide were used and formulated into a near theoretical cordierite composition, together with WO₃ corresponding to 5% of the cordierite constituent Si and CoO also corresponding to 5% Si. Appropriate amounts of a binder, lubricant, humectant and moisture were added to the starting material, and kneaded into a clay-like material which was then formed into a honeycomb shape having a cell wall thickness of 100 μm, a cell density of 400 cpsi and a diameter of 50 mm. After drying the honeycomb structure, it was fired in air at 1390° C. to obtain a ceramic carrier capable of directly supporting a catalyst component at the substituting elements (W, Co).

In order to load Pt and Rh as catalyst components into the obtained ceramic carrier, an ethanol solution was prepared containing 0.035 mol/L hexachloroplatinic acid and 0.025 mol/L rhodium chloride. The ceramic carrier was immersed in the solution for 5 minutes, the excess solution was removed by air blowing, and then drying was performed for 1 hour with a drier at 110° C. A honeycomb shaping lubricant (product name: UNILUBE, by Nissan Chemical Corp.) was then used as the reducing agent to prepare a solution comprising a mixture of the lubricant and water in a weight ratio of 1:1. The ceramic carrier supporting the catalyst component was immersed in this solution for 10 seconds, and after removing the excess solution and drying, it was sintered in air at 300° C. for metallization of the Pt and Rh to obtain a catalyst ceramic body according to the invention (Example 2).

For evaluation of the purification performance of the catalyst ceramic body of Example 2, the 50% purification temperature for C₃H₆ was measured, as for Example 1 above. As a result, the 50% purification temperature for Example 2 was 187° C., and when the catalyst particle size was measured by the CO adsorption method, the average was found to be 25 nm. It was thus confirmed that sintering with coating of a reducing agent can also lower the metallization temperature, and thereby, in comparison with Comparative Example 1 (50% purification temperature: 210° C., mean particle size; 55 nm), achieve a finer catalyst to achieve markedly improved purification performance.

### Example 3

A catalyst ceramic body according to the invention was manufactured by a method of using a weakly acidic, neutral or weakly basic starting material as the precursor for the catalyst component, and the effect was evaluated. The cordierite starting materials talc, kaolin, alumina and aluminum hydroxide were used and formulated into a near theoretical cordierite composition, together with WO₃ corresponding to 5% of the cordierite constituent Si and CoO also corresponding to 5% Si. Appropriate amounts of a binder, lubricant, humectant and moisture were added to the starting material, and kneaded into a clay-like material which was then formed into a honeycomb shape having a cell wall thickness of 100 μm, a cell density of 400 cpsi and a diameter of 50 mm. After drying the honeycomb structure, it was fired in air at 1390° C. to obtain a ceramic carrier capable of directly supporting a catalyst component at the substituting elements (W, Co).

In order to load Pt and Rh as catalyst components into the obtained ceramic carrier, an ethanol solution was prepared containing 0.075 mol/L tetraammine platinum sulfate (weak base) and 0.02 mol/L rhodium acetate (weak acid). The ceramic carrier was immersed in the solution for 5 minutes, the excess solution was removed by air blowing, and then drying was performed for 1 hour with a drier at 110° C. This was then sintered in air at 300° C. for metallization of the Pt and Rh to obtain a catalyst ceramic body according to the invention (Example 3).

For evaluation of the purification performance of the catalyst ceramic body of Example 3, the 50% purification temperature for C₃H₆ was measured, as for Example 1 above. As a result, the 50% purification temperature for Example 3 was 143° C., and when the catalyst particle size was measured by the CO adsorption method, the average was found to be 10 nm. It was thus confirmed that using a weakly acidic, neutral or weakly basic starting material can lower the metallization temperature, and that it is possible to lower the metallization temperature and achieve a finer catalyst to achieve markedly improved purification performance, in comparison with Comparative Example 1 (50% purification temperature: 210° C., mean particle size: 55 nm) using hexachloroplatinic acid (strong acid) and rhodium chloride (strong acid).

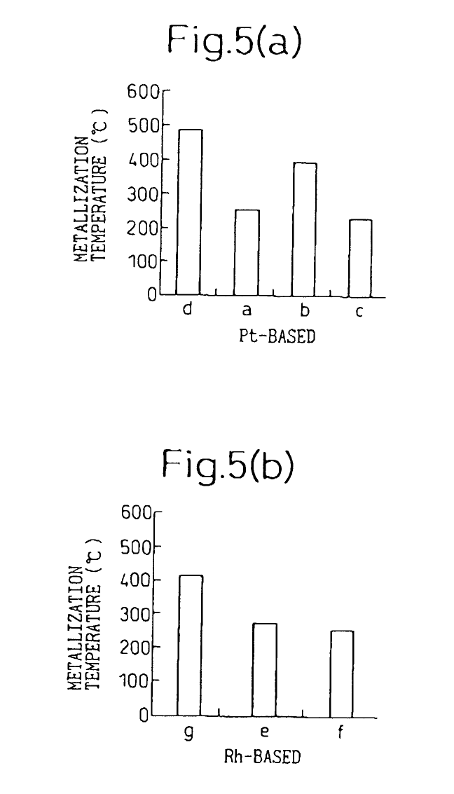

FIGS. 5(a) and (b) show the metallization temperatures for weakly acidic, neutral or weakly basic starting materials as precursors of Pt and Rh, in comparison with the metallization temperatures of strongly acidic starting materials. The metallization temperature was measured by heating each starting material in air and determining the weight, and the metallization temperature was recorded as the temperature at which a weight change was observed by dissociation of the salt. The metallization temperatures for Pt-based and Rh-based catalysts are listed below

| | | |
|---|---|---|
| Pt-based | a) Tetraammine platinum nitrate | 255° C. |
| | b) Tetraammine platinum chloride | 397° C. |
| | c) Platinum acetylacetonate | 229° C. |
| | d) Hexachloroplatinic acid | 487° C. |
| | (strong acid) | |
| Rh-based | e) Rhodium acetate | 275° C. |
| | f) Rhodium acetylacetonate | 257° C. |
| | g) Rhodium chloride (strong acid) | 413° C. |

As shown in FIG. 5, both hexachloroplatinic acid (strong acid) and rhodium chloride (strong acid) had metallization temperatures exceeding 400° C. in air, while the metallization temperatures of the weakly acidic, neutral and weakly basic starting materials were all 400° C. or below, thus confirming that the sintering temperature can be lowered.

What is claimed is:

1. A catalyst ceramic body comprising a catalyst component supported on a ceramic carrier, wherein said ceramic carrier is capable of directly supporting a catalyst component on the base ceramic surface, and said catalyst component is catalytically activated by sintering a precursor of said catalyst component in a reducing atmosphere.

2. A process for production of a catalyst ceramic body comprising a catalyst component supported on a ceramic carrier capable of directly supporting a catalyst component on the base ceramic surface, wherein the precursor of said catalyst component is loaded in said ceramic carrier and sintered in a reducing atmosphere.

3. A catalyst ceramic body according to claim 1, wherein the mean size of the supported catalyst particles is 100 nm or smaller.

4. A catalyst ceramic body according to claim 1, wherein a reducing gas is supplied into the sintering furnace to produce the reducing atmosphere.

5. A catalyst ceramic body according to claim 4, wherein said reducing gas is a gas containing H₂ gas, CO gas or a flammable gas.

6. A catalyst ceramic body according to claim 1, wherein after loading the precursor of said catalyst component, a reducing agent is coated onto the precursor of said catalyst component before sintering so that a reducing atmosphere forms at least near the precursor of said catalyst component.

7. A catalyst ceramic body according to claim 1, wherein the sintering temperature is lower than 600° C.

8. A catalyst ceramic body according to claim 1, wherein the precursor of said catalyst component is a salt containing said catalyst component.

9. A catalyst ceramic body according to claim 1, wherein said catalyst component is a catalytic precious metal.

10. A catalyst ceramic body according to claim 1, wherein the precursor of said catalyst component is any one selected from the group consisting of hexachloroplatinic acid, platinum nitrate, dinitrodiammine platinum, tetraammine platinum nitrate, tetraammine platinum chloride, platinum acetylacetonate, rhodium chloride, rhodium nitrate, rhodium acetate, rhodium acetylacetonate, palladium chloride, palladium nitrate, palladium acetate, palladium acetylacetonate, tetraammine palladium nitrate and tetraammine palladium chloride.

11. A process for production of a catalyst ceramic body according to claim 2, wherein the mean size of the supported catalyst particles is 100 nm or smaller.

12. A process for production of a catalyst ceramic body according to claim 2, wherein a reducing gas is supplied into the sintering furnace to produce the reducing atmosphere.

13. A process for production of a catalyst ceramic body according to claim 12, wherein said reducing gas is a gas containing H₂ gas, CO gas or a flammable gas.

14. A process for production of a catalyst ceramic body according to claim 2, wherein after loading the precursor of said catalyst component, a reducing agent is coated onto the precursor of said catalyst component before sintering so that a reducing atmosphere forms at least near the precursor of said catalyst component.

15. A process for production of a catalyst ceramic body according to claim 2, wherein the sintering temperature is lower than 600° C.

16. A process for production of a catalyst ceramic body according to claim 2, wherein the precursor of said catalyst component is a salt containing said catalyst component.

17. A process for production of a catalyst ceramic body according to claim 2, wherein said catalyst component is a catalytic precious metal.

18. A process for production of a catalyst ceramic body according to claim 2, wherein the precursor of said catalyst component is any one selected from the group consisting of hexachloroplatinic acid, platinum nitrate, dinitrodiammine platinum, tetraammine platinum nitrate, tetraammine platinum chloride, platinum acetylacetonate, rhodium chloride, rhodium nitrate, rhodium acetate, rhodium acetylacetonate, palladium chloride, palladium nitrate, palladium acetate, palladium acetylacetonate, tetraammine palladium nitrate and tetraammine palladium chloride.

19. A catalyst ceramic body comprising a catalyst component supported on a ceramic carrier, characterized in that said ceramic carrier is a ceramic carrier capable of directly supporting the catalyst component on the base ceramic surface, and said catalyst component is catalytically activated by sintering of a starting material other than a strong acid or strong base as the precursor of said catalyst component.

20. A process for production of a catalyst ceramic body comprising a catalyst component supported on a ceramic carrier capable of directly supporting a catalyst component on the base ceramic surface, the process for production of a catalyst ceramic body being characterized in that a starting material other than a strong acid or strong base is loaded in said ceramic carrier and sintered in air as the precursor of said catalyst component.

21. A catalyst ceramic body according to claim 19, wherein the mean particle size of the supported catalyst particles is no greater than 100 nm.

22. A catalyst ceramic body according to claim 19, wherein the sintering temperature is lower than 600° C.

23. A catalyst ceramic body according to claim 19, wherein a weakly acidic, neutral or weakly basic starting material is used as the precursor of said catalyst component.

24. A catalyst ceramic body according to claim 23, wherein the precursor of said catalyst component has a solution pH of 4-10 when the catalyst metal concentration is 0.01 mol/L.

25. A catalyst ceramic body according to claim 19, wherein said catalyst component is a catalytic precious metal.

26. A catalyst ceramic body according to claim 19, wherein the precursor of said catalyst component is at least one selected from the group consisting of tetraammine platinum nitrate, tetraammine platinum chloride, platinum acetylacetonate, rhodium acetate, rhodium acetylacetonate, palladium acetate, palladium acetylacetonate, tetraammine palladium nitrate and tetraammine palladium chloride.

27. A catalyst ceramic body according to claim 19, wherein the mean particle size of said catalyst particles is no greater than 50 nm.

28. A catalyst ceramic body according to claim 1, characterized in that said ceramic carrier is one which has a plurality of pores capable of directly supporting a catalyst on the base ceramic surface, and which is capable of directly supporting the catalyst component in the pores.

29. A catalyst ceramic body according to claim 28, wherein said pores are defects in the ceramic crystal lattice, fine cracks in the ceramic surface and/or loss of elements constituting the ceramic.

30. A catalyst ceramic body according to claim 29, wherein the widths of the fine cracks are no greater than 100 nm.

31. A catalyst ceramic body according to claim 28, wherein said pores have a diameter or width of up to 1000 times the diameter of the catalyst ion to be supported, and the number of said pores is 1×10¹¹/L or greater.

32. A process for production of catalyst ceramic body according to claim 20, wherein the mean particle size of the supported catalyst particles is no greater than 100 nm.

33. A process for production of a catalyst ceramic body according to claim 20, wherein the sintering temperature is lower than 600° C.

34. A process for production of a catalyst ceramic body according to claim 20, wherein a weakly acidic, neutral or weakly basic starting material is used as the precursor of said catalyst component.

35. A process for production of a catalyst ceramic body according to claim 34, wherein the precursor of said catalyst component has a solution pH of 4-10 when the catalyst metal concentration is 0.01 mol/L.

36. A process for production of a catalyst ceramic body according to claim 20, wherein said catalyst component is a catalytic precious metal.

37. A process for production of a catalyst ceramic body according to claim 20, wherein the precursor of said catalyst component is at least one selected from the group consisting of tetraammine platinum nitrate, tetraammine platinum chloride, platinum acetylacetonate, rhodium acetate, rhodium acetylacetonate, palladium acetate, palladium acetylacetonate; tetraammine palladium nitrate and tetraammine palladium chloride.

38. A process for production of a catalyst ceramic body according to claim 2, wherein the mean particle size of said catalyst particles is no greater than 50 nm.

39. A process for production of a catalyst ceramic body according to claim 2, characterized in that said ceramic carrier is one which has a plurality of pores capable of directly supporting a catalyst on the base ceramic surface, and which is capable of directly supporting the catalyst component in the pores.

40. A process for production of a catalyst ceramic body according to claim 39, wherein said pores are defects in the ceramic crystal lattice, fine cracks in the ceramic surface and/or loss of elements constituting the ceramic.

41. A process for production of a catalyst ceramic body according to claim 40, wherein the widths of the fine cracks are no greater than 100 nm.

42. A process for production of a catalyst ceramic body according to claim 39, wherein said pores have a diameter or width of up to 1000 times the diameter of the catalyst ion to be supported, and the number of said pores is 1×10¹¹/L or greater.

43. A catalyst ceramic body according to claim 1, wherein said ceramic carrier has one or more elements of said base ceramic substituted by an element other than a constituent element, wherein said catalyst component can be directly supported on the substituting element.

44. A catalyst ceramic body according to claim 43, wherein said catalyst component is supported by being chemically bonded to said substituting element.

45. A catalyst ceramic body according to claim 43, wherein said substituting element is one or more than one type of element having a d or f orbital among its electron orbitals.

46. A catalyst ceramic body or a process for its production according to any one of claims 1, 2, 19 or 20, wherein said base ceramic contains cordierite as a component.
